(19) United States
(12) Patent Application Publication
(10) Pub. No.: US 2010/0192498 A1
(43) Pub. Date: Aug. 5, 2010

(54) BUILDING SYSTEM

(76) Inventor: William B. GLECKMAN, New York, NY (US)

Correspondence Address: COLLARD & ROE, P.C., 1077 NORTHERN BOULEVARD, ROSLYN, NY, 11576, US

(21) Appl. No.: 12/626,494

(22) Filed: Nov. 25, 2009

Related U.S. Application Data
(60) Provisional application No. 61/148,480, filed on Jan. 30, 2009.

(51) Int. Cl. E04C 2/34; B23P 17/00; E04C 2/30; E04C 2/38

(52) U.S. Cl. 52/475.1; 29/897.32; 52/794.1; 52/582.1

(57) ABSTRACT

A building system can be made from a structural member and a panel. The panel can be made from a plurality of sheets while each of the sheets can be made from steel sheets which are coated with an alloy such as an aluminum zinc allow to form a galvalum sheet. This galvalum sheet can then be coated with a ceramic insulating material on one or both sides of the sheet. These two sheets can be spaced apart from each other to house an insulative barrier in between. This insulative barrier can include one or more layers of air, and/or basalt continuous fiber. Each panel can be sealed so that it doesn't allow for air convection.

### CROSS REFERENCE TO RELATED APPLICATIONS

This application is a non provisional application and hereby claims priority from provisional application Ser. No. 61,148,480 filed on Jan. 30, 2009 the disclosure of which is hereby incorporated herein by reference in its entirety.

### BACKGROUND OF THE INVENTION

The invention relates to a building system/building panel and/or building sheet. In addition the invention relates to a process for making a building panel.

### SUMMARY OF THE INVENTION

One embodiment of the invention relates to a building system. Another embodiment of the invention relates to a building panel. Another embodiment of the invention relates to a building sheet.

With the case of the building sheet, this sheet can be in the form of a coated steel sheet which can be in the form of a corrugated or flat rolled sheet. The steel sheet can be either a sheet made from steel alone, or a steel composite. For example, the steel composite or alloy can be in the form of a galvanized steel, or a steel coated with an aluminum zinc alloy. The steel, in combination with aluminum zinc alloy can be in the form of a galvalum sheet of steel.

Another coating on the sheet can be in the form of a non metallic coating. The non metallic coating can be in the form of a ceramic coating which is applied in a manner similar to paint. For example, the non-metallic coating can be in the form of an epoxy such as a ceramic/polymer epoxy, that can comprise a plurality of different ceramics forming at least one heat insulative layer. This non metallic coating can be in the form of a Supertherm® ceramic/polymer epoxy. The sheets can be in the form of flat rolled sheets or in the form of corrugated steel decking. In one case, if corrugated steel decking is used then this corrugated steel decking can be spaced apart from each other

In the making of the panel, these sheets in any of the above forms can be spaced apart from each other but coupled to adjacent materials to form a sealed interior to restrict air movement. The sealing of air inside of this panel between the two sheets forces the air to act as an insulator with little to no convection or movement of air from one side to the other, or from inside the panel to outside of the panel.

The sealing of the air is accomplished by sealing a peripheral region around the spaced apart sheets. In addition an intermediate insulative material can be disposed between these two sheets to reduce the incidence or possibility of air flow between these sheets. This insulative material can be in the form of basalt continuous fiber (BCF).

Each of these panels can be coupled to an adjacent structural member in the form of a column or beam as well to form a building system. In this case, a structural member can be any shape, and in at least one embodiment it is C-shaped. This structural member can be made from a substantially rigid material such as steel, galvanized steel or any other structurally rigid material. If the structural member is substantially vertically orientated, then it will be hereinafter referred to as a column. If the structural member is substantially horizontally orientated, then it will be hereinafter referred to as a beam. If the structural member is substantially orientated at a 45 degree angle with respect to the ground then it will be referred to as a diagonal support.

The uniqueness of the sheet, the panel and the building system is based upon the materials used. For example, the sheet comprises a solid metallic sheet that is coated with a non-metallic insulative layer on at least one side. This coating thereby improves the insulative properties of the sheet. With two sheets being spaced apart from each other, the level of heat conduction is dramatically reduced.

While the sheet as described above can be made from any material, it is most likely made from a metal such as a ferrous metal such as steel. While the thermal conductivity of steel can be relatively high, the thermal conductivity of a non metallic coating is quite lower.

To preserve the sheet and keep it from oxidizing, as well as to enhance the thermal properties of the sheet, alloying elements can be used. Some of the alloying elements that can be used are zinc, and aluminum. One product that can be used is Galvalume®.

For example, one sheet can be in the form of a 55% aluminum-45% zinc alloy coated sheet steel developed by Bethlehem Steel and sold commercially under the trademark Galvalume®,

Both Galvalume® and galvanized sheet steels are made by a “continuous hot dip” process. Coils of cold rolled steel are welded end-to-end and processed continuously on the coating line at speeds up to 600 feet per minute. The uncoiled sheet is first cleaned to remove rolling oils and mill dirt, and to reduce surface oxides so that the surface will accept the coating. These continuous sheets are first fed into a molten coating bath contained in an open top, brick-lined heated pot. The sheet then passes around a roller submerged in the coating bath and exits the bath vertically, pulling out with it an envelope of the coating material. As it exits, the sheet proceeds through a pair of opposing air knives, which are positioned above the bath and equidistant from the surface of the sheet. Most modern production lines have a coating thickness gauge feed-back control, which automatically adjusts knife air pressure and position to ensure that a uniform coating is applied. Various finishing steps are carried out to complete the process, after which the sheet is wrapped around a reel into a coated steel coil.

Once the steel sheet is made it can be coated. The coating process can include coating on one side, on both sides or all around the exterior either by painting spraying, dipping or any other known method. The insulative coating on the sheet can be in the form of a ceramic coating which can be in the form of a paint, epoxy etc. This ceramic based coating can include multiple different ceramics, bound together using a binder such as a polymer. In at least one case, the ceramic portion of the mixture is at least approximately 30%, and in particular at least approximately 35%, while the polymer portion of the solution can be at least approximately 60% and even at least approximately 65%.

This type of insulative ceramic coating can come in the form of a product called Super Therm®. Super Therm® is a ceramic based, water-borne, insulating coating, designed to block heat load, moisture penetration, and air infiltration over a surface and to reduce energy costs. SuperTherm® reflects over 95% of the three radiation sources from the sun, which are ultraviolet, visual light and infra red rays.

One of the benefits of a ceramic coating such as Super Therm®, is in the form of Energy Savings. Super Therm® can provide energy savings of 20-70%. These savings can vary according to use and application.

For example, when applied properly, a ceramic coating such as Super Therm® reflects over 95% of radiation from the sun replacing the 6 to 8 inches of traditional insulation to block initial heat load.

In addition, a ceramic/polymer coating can act to block moisture and air infiltration. This ceramic/polymer coating which can be in the form of Super Therm® can have a class A Fire Rating. In this case, the ceramic/polymer coating will not contribute and will resist the spread of fire.

The ceramic/polymer coating consists of a specially tuned compound of 4-different ceramics “Thermo-Dynamically Tuned to cover the infrared (IR), ultraviolet (UV), & Visible Light Spectrum, {the Thermal Spectrum from −40°-C to 360°-C; as well as up to and over 60% such as 68% of the Sound Spectrum. By varying the Mass, Size, Shape, Ratios, and Quantity of selected ceramics, one can tune the thermo-dynamic properties of the Ceramic compounds to block out the desired thermal frequencies.

At least one sheet is made from basalt continuous fiber BCF also known as continuous basalt fiber CBF. This fiber is spun from basalt.

Basalt is a hard, dense, dark volcanic rock composed chiefly of plagioclase, pyroxene, and olivine, and often having a glassy appearance. The name “basalt” is usually given to a wide variety of dark-brown to black volcanic rocks, which form when molten lava from deep in the earth's crust rises up and solidifies. Basalt deposits frequently cover areas on many thousands of square kilometers. Basalt differs from granite in being a fine-grained extrusive rock and having a higher content of Iron and Magnesium. The density of basalt rock is between 2.8 and 2.9 g/cm³. It is also extremely hard—5 to 9 on Mho's scale. This gives basalt a superior abrasion resistance and casted basalt is often used as a paving and building material. While the commercial applications of cast basalt have been well known for a long time, it is less known that basalt can be formed into continuous fiber having unique mechanical and chemical properties.

The fibers or the fiber sheet made from BCF comprise unique qualities as well. For example, below are the listed characteristics of Basalt Continuous Fiber (BCF, or CBF)

### Basic Characteristics & Advantages CBF

TABLE 1
Comparative Characteristics Between CBF Fiber & Other
Fiber Capability CBF E-glass fiber S-glass fiber Carbon fiber

| | Capability | E-glass | S-glass | Carbon |
|---|---|---|---|---|
| | CBF | fiber | fiber | fiber |
| Tensile | 3000~4840 | 3100~3800 | 4020~4650 | 3500~6000 |
| strength MPa | | | | |
| Elastic | 79.3~93.1 | 72.5~75.5 | 83~86 | 230~600 |
| modulus gPa | | | | |
| Elongation at | 3.1 | 4.7 | 5.3 | 1.5~2.0 |
| break | | | | |
| Diameter of | 6~21 | 6~21 | 6~21 | 5~15 |
| filament, mμ | | | | |
| tex | 60~4200 | 40~4200 | 40~4200 | 60~2400 |
| Price, USD/kg | 2, 5 | 1, 1 | 1, 5 | 30 |
| Temperature of | −260~+500 | −50~+380 | −50 +300 | −50~+700 |
| application °Ñ | | | | |
| Elongation at | 3.1 | 4.7 | 5.3 | 1.5~2.0 |
| break | | | | |

The basalt fiber can provide an insulative feature in addition the Strength-to-weight ratio of a basalt fiber exceeds strength of alloyed steel by 2.5 times, and the strength to weight ratio of fiber glass—by 1.5 times.

High chemical durability to impacts of water, salts, alkalis and acids. Unlike metal, CBF is not affected by corrosion. Unlike fiber glass, CBF is not affected by acids. CBF possess high corrosion and chemical durability qualities towards corrosive mediums, such as salts & acids solutions and, especially, alkalis. CBF has a relatively high thermal resistance. In addition, CBF is highly compatable with other materials (metals, plastic, glues) during producing process.

Materials made on CBF basis can be processed with application of different “cold” technologies, such as molding, winding, pultrusion, sputtering, etc.

One of the reasons for creating a multi-layer sheet as well as a multi-layer panel is due to the varying levels of thermal conductivity of the different components. Structural steel sheets provide a resilient structure in which to build a building. However, a single steel sheet alone may not provide sufficient thermal insulation for a resident of a dwelling. Therefore, different materials of different thermal conductivity are used.

The thermal conductivity of air at 25 degrees celsius is 0.024 k-(W/mK), while the thermal conductivity of fiberglass at 25 degrees celcius is 0.04. In addition, the thermal conductivity of a pane of glass is 0.96. Therefore, for insulation purposes, it is more efficient and obviously less expensive to use air as an insulator rather than a material such as fiberglass. Basalt continuous fiber is also used for its low thermal conductivity. For example, the basalt continuous fiber has a thermal conductivity of 0.035 W/m·K. In addition, another feature is that the basalt continuous fiber acts as a sound barrier. BCF has a relatively high sound absorption coefficient: 0.95 and a low moisture absorption of 0.1%, Permanent flame retardant resistance: with a Limiting oxygen index (Loi) >70.2, and a Extraordinary high softening temperature (point): >1200 Celsius degree. Therefore, the sheet along utilizes both a steel sheet alone with either an alloying coating or a ceramic coating to reduce the thermal conductivity. In addition, the panel itself forms a sealed panel which has sealed layers of air and basalt continuous fiber to reduce the thermal heat transfer between the outside of a building or structure and the inside of a building or structure.

As indicated above, the sheets when coupled together with BCF, and which are spaced apart with a sealed air gap can be formed as a panel. Each of the panels has at least one connector region, with each of the panels being connectable together to form a building structure based upon a continuous building system.

This system uses sealed air as the most effective and least costly insulation. The sealing is accomplished by means of SUPERTHERM®, a water-based ceramic-filled coating of which two ceramic compounds repel more than 95% of solar radiant energy, another ceramic compound stops 92% of heat transfer by hollow sphere technology (not glass) and a fourth ceramic compounds is designed specifically to stop infrared heat and prevent it from loading onto buildings. It further provides water-proofing, zero flame spread, resistance to mildew growth and blocks air flow with its associated moisture and air-borne sound and further acts as a strong adhesive to bond basalt fiber mat to the building structure.

The system uses basalt continuous fiber mats which include the following characteristics: they are highly resistant to fire and high temperature; have high thermal insulation superior to glass- and mineral fiber; they are highly resistant to acid and alkalis, superior to glass- and mineral fiber; they have low hygrometry (+/−1% over time), superior to that of fiberglass; have long-term corrosion resistance; do not create conditions for growth of microorganisms, do not decay and are not destroyed by insects, worms, rodents or fungi; are vibration resistant; are chemically resistant to hot acids, sewerage and other aggressive liquids; provide protective screening against electromagnetic radiation, and are relatively safe, environmentally friendly and do not smell.

In addition some of the benefits of this system are that it uses air as the most effective and least costly insulation material; it uses basalt continuous fiber mats which: have high resistance to fire and high temperature, have a high thermal insulation exceeding that of glass- and mineral-fibers, have a high acid- and alkali-stability, exceeding that of glass, have low hygroscopity (+/−1% over time), superior to that of glass-fiber, have high, long-term corrosion resistance, do not create conditions for growth of microorganisms and do not decay; are vibration-resistant due to the elasticity of its micro- and macrostructure; are chemically resistant to hot acids, sewerage and aggressive liquids; provide protective screening against electromagnetic radiation; are safe physiologically, environmentally friendly and do not smell; are made from one of the least expensive and most common elements in Nature, mined in virtually every country of the world. For example, 95% of the ocean floor is composed of basalt.

In combination with SUPER THERM® insulating coating, a water-based, unique ceramic-filled coating of which two ceramic compounds can repel more than 95% of the sun's radiant energy, another ceramic compound stops approximately 92% of heat transfer by hollow sphere technology (not glass) and a fourth ceramic compound designed specifically to stop infrared and prevent it from loading onto buildings. It further provides water-proofing, zero flame spread, resistance to mold/mildew growth, blocks air flow with its associated moisture, blocks air-borne sound and acts as a strong adhesive to bond basalt fiber mat to the building unit panels.

The method is an improvement over what currently exists in that it provides a low-cost insulation by making use of air spaces sealed between glass, metal or other materials in a layering analogous to that of thin jackets and wool sweaters that skiers use; it makes full use of air which is the least costly and most efficient insulation known with “k” value of 0.024 W/m·dK.; it is far less costly than other super insulations such as aerogels which are too fragile for use in buildings and extruded polystyrene, a fire hazard; it makes use of specially strong steel framing secured by high-strength socket bolts and/or self-drilling screws eliminating the necessity for welding, and which can be pneumatically driven into terrain without despoiling it to provide strong footings braced against wind and seismic forces, eliminating the need for excavation and concrete foundations; it makes use of thin steel units for finished floors, walls and roofs eliminating the need for drywall, taping, spackling, tile work, wood and exterior cladding. In this case, chases for ventilating air are incorporated within the floor construction eliminating ductwork, hung ceilings and enabling lower floor-floor heights.

The combination of Supertherm coating over air lamina septa and basalt fiber mats fulfills another purpose of insulation: it cuts heat loss and controls surface temperature. A 10 mil coating of Supertherm cuts the surface temperature of an uncoated tar roof @ 135 dF down to 90 dF. No more than those 10 mils is necessary to control the surface temperature. Thus the coating prevents radiant solar energy from bombarding the electrons of the building surface then bouncing them out of orbit and onto people, streets and other buildings and so on which causes the sensation of heat on those surfaces receiving the second “bounce”. In so doing it also prevents the entry of heat into the mass of the building's matrix and prevents that mass from acting as a “heat sink”. Proper insulation means not just heat transfer control but also surface temperature control. Heat is not temperature and temperature is not heat. The first is measured in calories or Btu's and the other in degrees C. or F. For truly effective insulation these issues as well as water and moisture control must be addressed and that is the function of Supertherm-coated fire-resistant basalt fiber mats and building surfaces.

Acoustic insulation control is resolved in the same manner. There are two aspects that must be addressed: air-borne noise and impact vibration. By employing two sheets of thin steel coated both sides with Supertherm and providing an air space between them airborne sound control is achieved without the necessity for the studs, furring channels, screws and fiber blankets used today. Impact resistance is provided via basalt fiber mats placed over and/or under the steel framing of floors and walls.

The basalt fiber mats can provide two hour fire protection to the steel framing of walls floors and roofs and are far less costly than the concrete and other cementitious materials used today for this purpose.

Finally because these panels are sealed and they are aesthetically pleasing to the eye, there is no need to add wood, tile, sheet rock, or any other finish material because the installed assembly is ready to use.

### BRIEF DESCRIPTION OF THE DRAWINGS

Other objects and features of the present invention will become apparent from the following detailed description considered in connection with the accompanying drawings which disclose the embodiments of the invention.

In the drawings, wherein similar reference characters denote similar elements throughout the several views:

FIG. 1A is a side view of a first sheet;

FIG. 1B is a side view of a second sheet;

FIG. 1C is a side view of a third sheet;

FIG. 2A is a side cross-sectional view of a first panel;

FIG. 2B is a side cross-sectional view of a second panel;

FIG. 2C is a side open face view of a panel;

FIG. 3A is a side cross-sectional view of another panel;

FIG. 3B is a side cross-sectional view of another panel;

FIG. 3C is a side cross-sectional view of another panel;

FIG. 4 is a flow chart for making the sheets and panels;

FIG. 5 is a side cross-sectional view of another sheet;

FIG. 6A is a side cross-sectional view of another panel;

FIG. 6B is a side cross-sectional view of another panel having the C-shaped spacers;

FIG. 7 is a side cross-sectional view of a window system;

FIG. 8 is a side cross-sectional view of a structure using the panel;

FIG. 9 is a side cross-sectional view of a sheet used to insulate a radiator;

FIG. 10 is a side cross-sectional view of another panel;

FIG. 11 is a side cross-sectional view of another panel;

FIG. 12 is a side cross-sectional view of a non load bearing partition panel;

FIG. 13A is a side cross-sectional view of a non load bearing partition on rollers;

FIG. 13B is a side cross-sectional view of a load bearing exterior wall on rollers; and

FIG. 14, is a side cross-sectional view of a rolling room;

FIG. 15A is a first embodiment of a panel having a clip end;

FIG. 15B is a second embodiment of a panel having a clip end;

FIG. 15C is a view of the two clip ends coupled together;

FIG. 16 is a side cross-sectional view of a partition/stop/jamb;

FIG. 17A is a side cross sectional view of a side partition base;

FIG. 17B is a side cross-sectional view of a side partition head;

FIG. 18A is a side cross-sectional view of a side non-structural wall;

FIG. 18A is a side cross-sectional view of a structural member which serves as a floor; roof; or wall.

### DETAILED DESCRIPTION

The following drawings represent different structures and building systems using the building panel and/or the building sheet. Multiple different embodiments are shown while multiple different variations are possible using different building components and building sheets to form the panel and the building system.

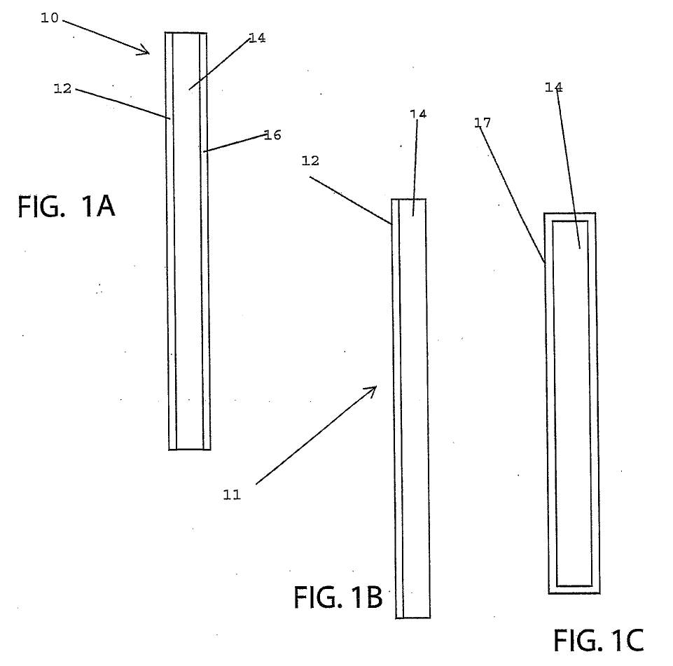

For example, FIG. 1A shows a side cross-sectional view of a building sheet 10 which includes the following layers, a first ceramic layer 12, an intermediate layer 14 comprising a steel alloy comprising a mixture of steel, aluminum and zinc which is commonly referred to as Galvalum®. In addition there is a third layer 16 comprising a ceramic layer as well.

FIG. 1B shows another embodiment of the building sheet 11 coated only on one side with a first coating 12 and the intermediate layer 14. FIG. 1C shows a building sheet covered on all sides by ceramic coating 15. In this case, the building sheet 10 is dipped into a ceramic coating so that it is coated on all sides.

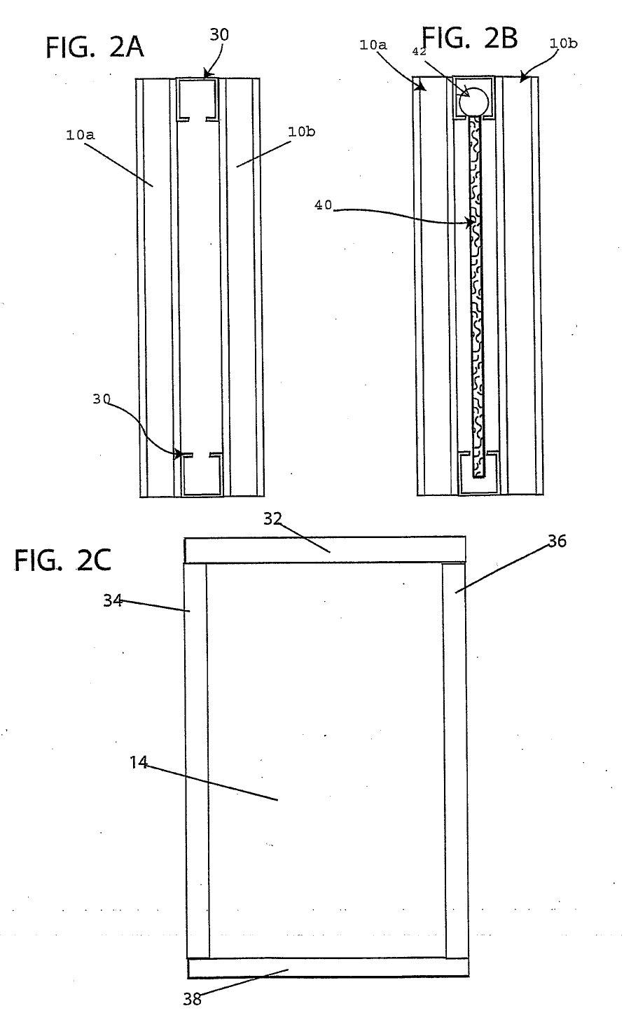

FIG. 2A shows a cross sectional view of a panel formed from two of these sheets shown in FIG. 1A. While the panel can be formed from the sheets shown in FIG. 1B this panel is shown by way of example using the sheets of FIG. 1A. In this case, the panel 20 comprises building sheets 10a and 10b which are essentially sheets 10 shown in FIG. 1A, wherein these sheets are spaced apart from each other via an air gap 22. Intermediate structure 30, comprises framing material which can optionally be coated with the ceramic insulator. This intermediate structure comprises framing material which can be formed as a C-shaped cross-sectional beam shown in FIGS. 2A and 2B. FIG. 2B shows an intermediate sheet of basalt continuous fiber BCF 40 coupled to and hanging from C shaped structural member 30 via a coupling element 42. In this case, the coupling of this intermediate insulator 40 can be in any known way such as by hooks, or slotting the intermediate insulator into a track.

This C-shaped cross-sectional beam can be formed from any material but in this case is formed from a steel C-shaped structural beam. Seals 32 and 34 are shown formed between intermediate structure 30 and sheets 10a and 10b.

FIG. 2C shows a side cut away view of this panel 10 showing one sheet removed. The intermediate structure 30 is shown surrounding the periphery of the panel, such a seal 31 is formed around the periphery of this panel to form a sealed panel structure. As shown, intermediate structure 30 can include framing members 32, 34, 36, and 38 extending around a periphery of the panel.

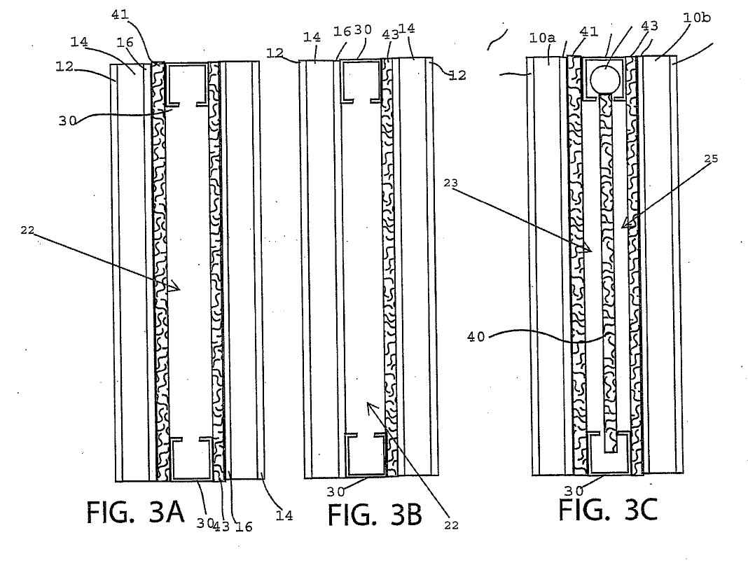

FIG. 3A shows another embodiment of the panel comprising an intermediate insulator 41 coupled to framing material 30. This intermediate insulator comprises a non metallic insulator such as a mineral insulator such as basalt continuous fiber. The basalt continuous fiber can be woven into a sheet or blanket forming an intermediate insulator 40, 41, or 43. In this embodiment, intermediate insulator 41 is coupled to framing or intermediate structure 30 on one side and coupled to sheet 10A on the other side. In this case, intermediate insulator 41 is essentially glued or dried onto coating 16 such that it coating 16 forms an adhesive bond with insulator 41 to couple this insulator 41 to the sheet. In this case, air gap 22 is shown disposed in between.

Similarly, insulator 43 is coupled on one side to framing or intermediate structure 30 via an adhesive or any other known adhering means or fastener and then coupled on the other side to sheet 10B via coating layer 16 on sheet 10B. Air gap 22 is shown disposed in between.

FIG. 3B shows another version which shows the use of only intermediate insulator 43 on one sheet 10B.

FIG. 3C shows a variation which is a combination of the embodiments of FIGS. 2C and 3A showing intermediate insulators 41, 40, and 43 disposed between panels 10A and 10B forming intermediate air gap layers 23 and 25.

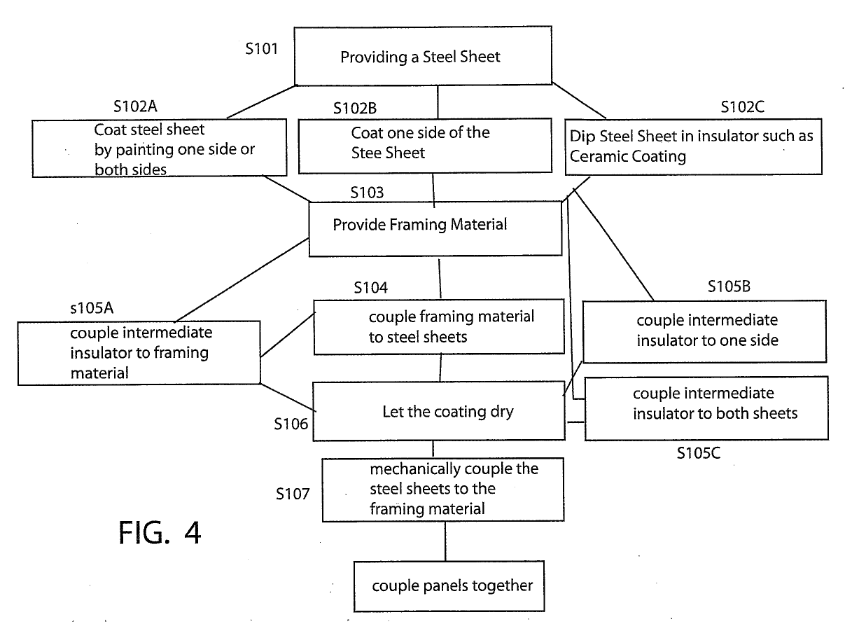

FIG. 4 is a flow chart for the process for producing the panel shown in FIG. 2A. In this case, the first step S101 includes providing a steel sheet, which can optionally be in the form of a steel alloy such as a galvanized sheet of steel either alloyed or coated with aluminum such as steel sheet 14. Optionally in step 102a, the sheet of steel can be dipped into a ceramic coating such as coatings 12 or 16 to cover either a substantial portion or the entire sheet of steel. Next, in step 102b the second sheet of steel such as steel sheet 14 can be coated such that in step 102c the sheet can also be optionally dipped to form a coated sheet of steel such as with coatings 12 and 16. Next, in step 103, framing material, such as framing material 30 is provided. Next, in step 104 this framing material is then coupled to each of the sheets of steel to form a sealed panel.

In step 106, the panel is then dried to form the seals surrounding the periphery of the panel.

There are also optional steps, for example, optional step 105a comprises attaching an intermediate insulator to the framing material 30. Another optional step such as step 105b includes attaching additional insulative material such as BCF to a first sheet. This attachment can occur before the insulative coating on the steel sheet has dried. Another optional step such as in step 105c includes attaching the additional insulator to both sheets. This additional insulator can be in the form of the intermediate insulator such as basalt continuous fiber 30. Once the insulator has been applied, the steel sheet with the ceramic coating is allowed to dry, such as in step S106 causing the BCF sheet to adhere to the ceramic coating. Next, in step S107 the steel sheets are mechanically coupled to the framing material. In this case, the mechanical coupling could occur via any known mechanical coupling process such as bolting, clamping riveting, welding, or any other known fixing process.

Next, in step 108, the different panels are coupled together as well.

It is noted that the steel sheets and the framing material are coupled together in a way to form either a completely air tight seal or a relatively air tight seal to form an air insulation zone between the two sheets.

Depending on the type of weather present in the region where these panels are being installed, the distance or number of insulation layers can be varied. For example, the framing material can be formed as being of different widths. In addition, additional intermediate insulators can be added to provide additional air insulation layers. In this case, additional sets of framing members can be coupled together to form a single panel unit. Alternatively, two different panels can be coupled together to form a double insulative layer which provides further insulation against outside elements.

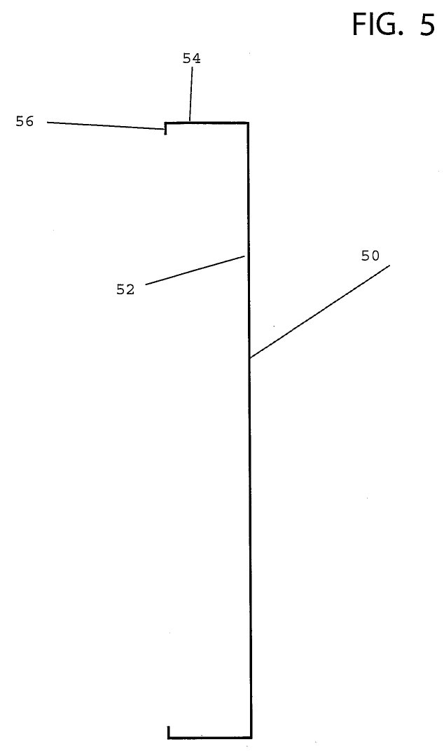

FIG. 5 shows another sheet which can be used as an insulator. This sheet 50 is essentially C-shaped and has a body section 52 an extending section 54, and a lip section 56. The sheet can be rolled, punched or made in any other known manner. This sheet can be made from any known material, but in this case can be made in a manner similar to sheet 10 shown in any one of FIG. 1A, 1B, or 1C which can include a substantially steel sheet which can be coated with an alloy such as a Galvalume® sheet. The sheet in at least one embodiment is coated with a ceramic and/or polymer coating to form an insulative layer such as described above regarding FIGS. 1A, 1B and 1C.

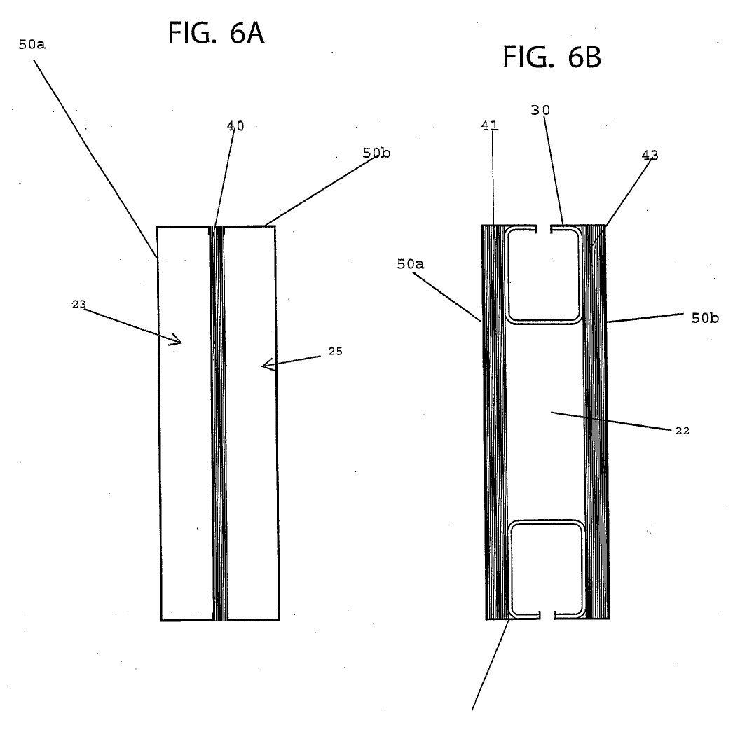

FIG. 6A shows a side cross-sectional view of a first panel 60 having a first sheet 50a a second sheet 50b and an intermediate insulator 40 coupled to first sheet 50a and second sheet 50b. Disposed between these two sheets 50a and 50b are air gaps 23 and 25 formed by the C-shaped profile of sheets 50a and 50b.

FIG. 6B shows a side cross-sectional view of a second panel showing structural members 30 disposed between sheets 50a and 50b. Coupled to sheet 50a is an insulator 41 while coupled to sheet 50b is an insulator 43. Insulators 41 and 43 are coupled to these sheets in any known manner, such as disclosed above with regard to FIGS. 3A-3C. Air gap 22 is shown disposed in between.

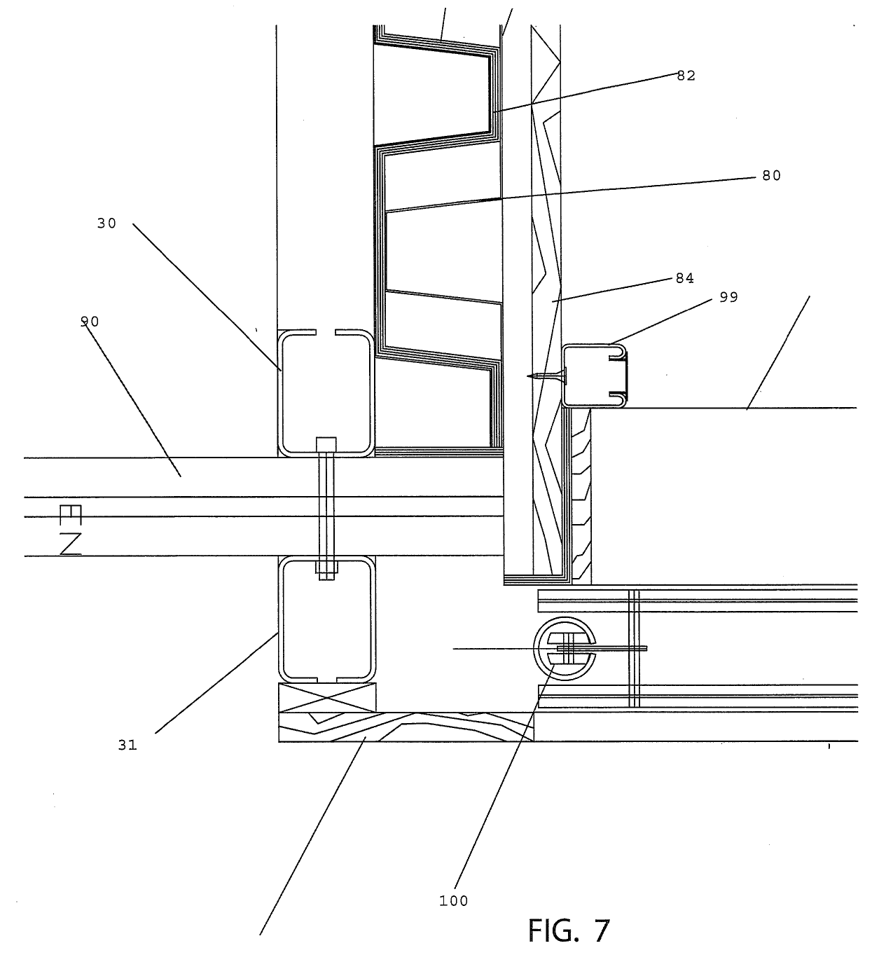

FIG. 7 is a side, cross sectional view of a structural member 30 having corrugated panels 80, 82 spaced apart from each other forming air gaps 83, with a wall surface 84 coupled thereto. An additional structural member 31 is coupled beneath a floor 90. In addition, a roller 100 is also shown which allows another surface such as a ceiling 110 to be moved along in an axial manner. Roller 100 includes a C-shaped or substantially circular or cylindrically shaped pipe which has rollers disposed therein, allowing a ceiling to move axially. There is also an additional raceway 99 which is coupled to wall surface 84. This raceway can be used to store or hide electrical wiring or other types of elements. In this case, corrugated panel 82 has BCF fiber coupled thereto.

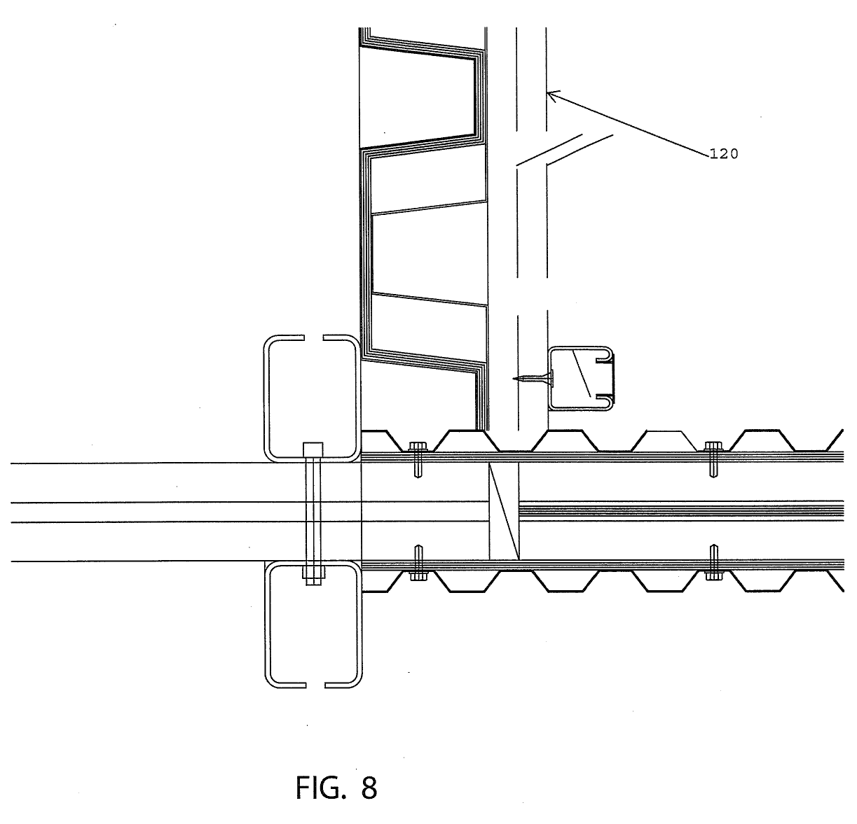

FIG. 8 shows as similar design which is constructed for use with windows 120.

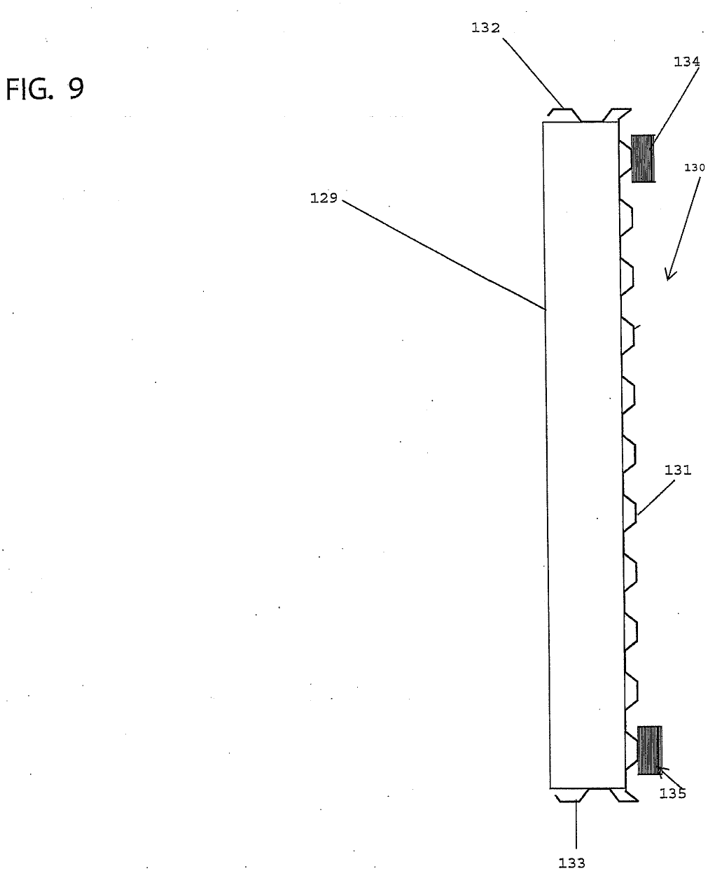

FIG. 9 shows a design for use with a heating element such as a radiator 129. In this case, with this design, there is a corrugated sheet 130 which has a first section 131, a second top section 132, a bottom section 133, and spacers 134 and 135. The radiator 129 is thereby insulated from heat loss via the different air pockets 138 formed between the corrugated sheet and the radiator.

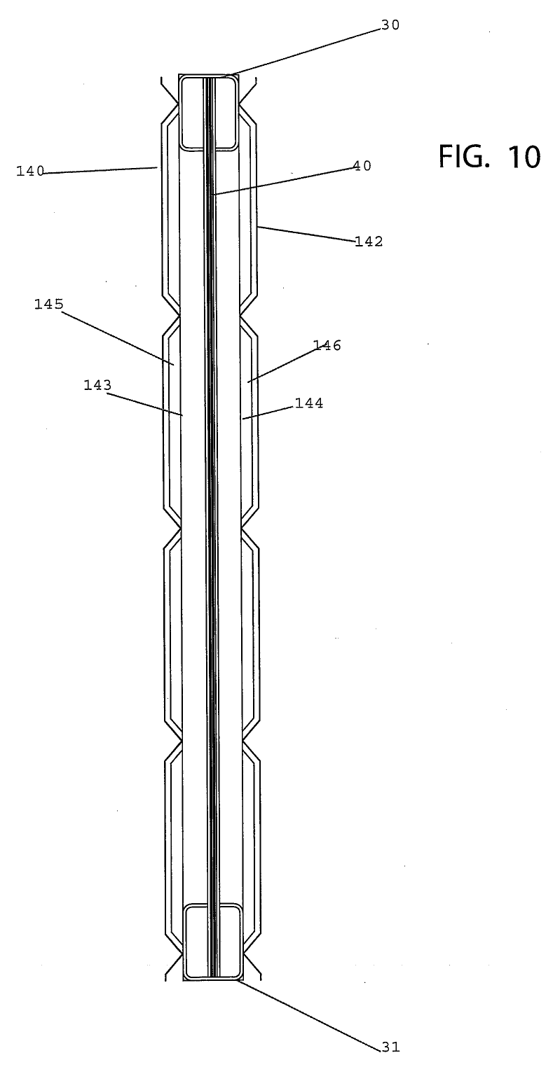

FIG. 10 shows a side cross-sectional view of another embodiment of the invention wherein there is shown a first corrugated sheet 140, a second corrugated sheet, and two structural elements 30 and 31 which are used to space the two corrugated sheets apart. Coupled to each of the structural members 30 and 31 on their outside surfaces are internal sheets 143 and 144 which are used to form air gaps 145 and 146. The sheets 140 and 142 can be sealed to the outer surface of structural members 30 and 31 to form an air gap. In addition, there is a sheet of basalt continuous fiber BCF 40 which is coupled to each of the structural members 30 and 31.

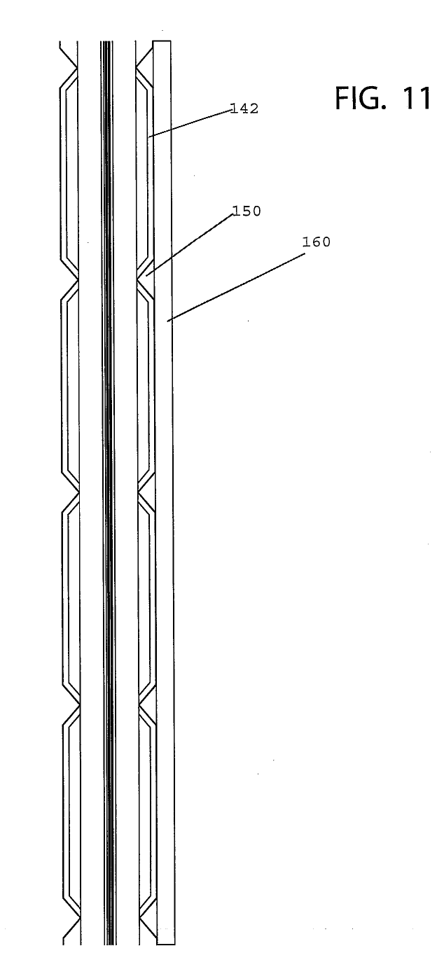

FIG. 11 shows corrugated sheet 142 which can be coupled to another surface element 160 such as sheet rock or other wall surface elements such as wood. In this connection additional air gaps 150 can be formed, which allow for the threading of electrical wiring to be fed therein.

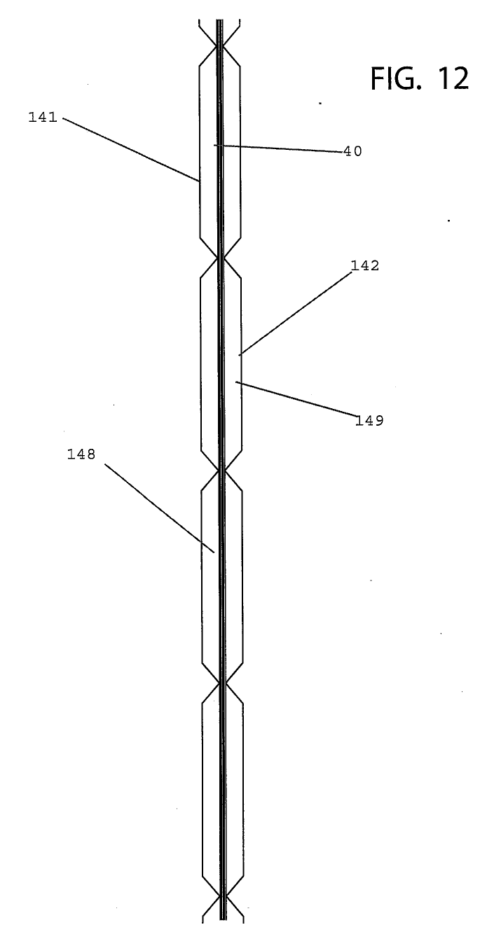

FIG. 12 shows a cross sectional view of another panel in the form of corrugated sheet 141, BCF sheet 40 and additional corrugated sheet 142. In addition, sealed air gaps 149 are formed between BCF sheet 40 and sheet 142. Air gaps 148 are also formed as well, these air gaps are disposed between sheet 142 and BCF sheet 40. The sealing of these air gaps can be due to the connection of BCF sheet 40 with a coated but not yet dried sheet 142 which is coated with a thermal insulator such as Supertherm®. When the coating dries it forms a substantially or entirely air tight seal.

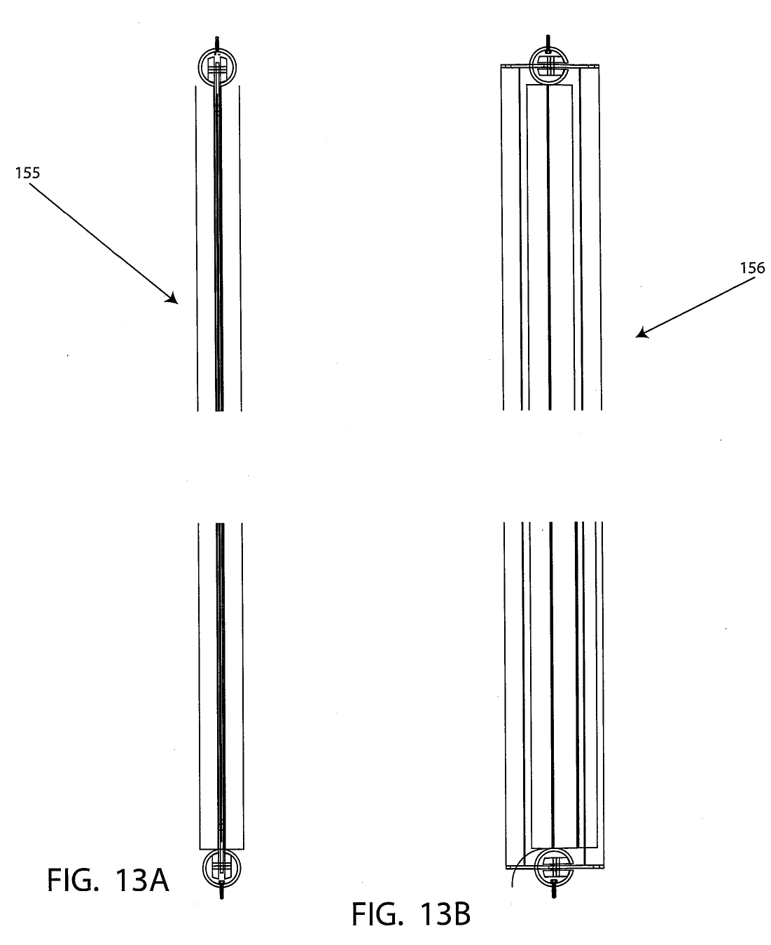

FIG. 13A shows a movable or rolling partition which is in the form of a partition wall 155. In addition FIG. 13B shows a moving or rolling partition 156 which is in the form of a structural wall.

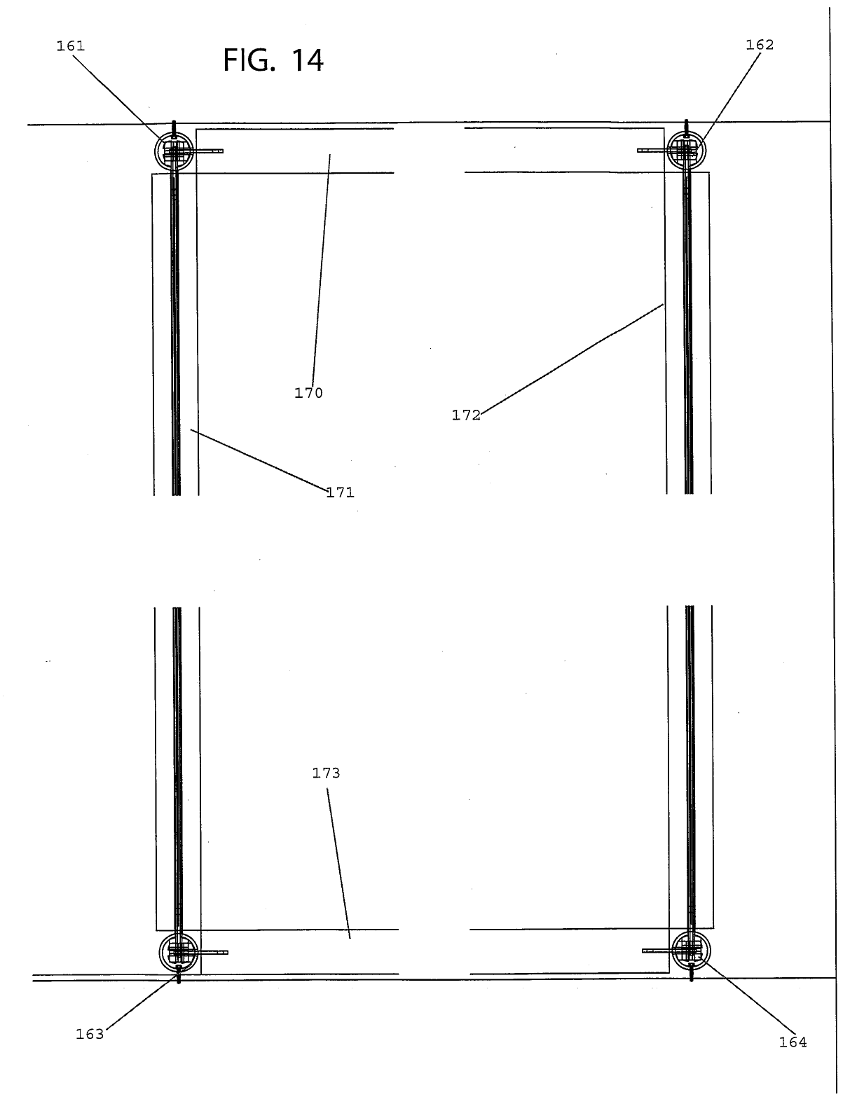

FIG. 14 shows a movable room using these panels which includes a plurality of rollers 161, 162, 163, and 164 which allow ceiling 170 and walls 171, and 172 along with floor 173 to move in unison so that the entire room can move out.

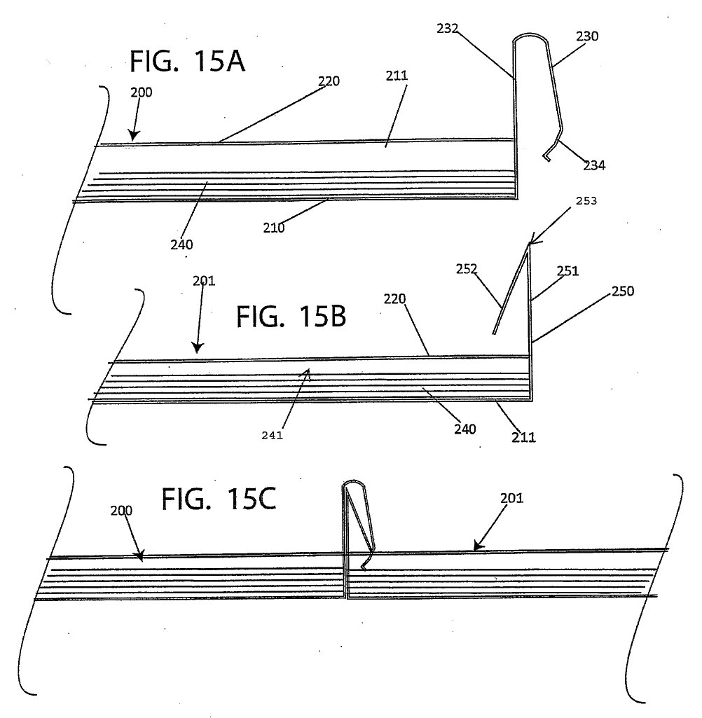

FIG. 15A is a side cross-sectional view of another embodiment which includes panels having clip ends. These clip ends allow the panels to be snapped together so that they can be clicked in easily without tools. For example, there is a panel 200 having a steel coated surface 210 similar to that shown in FIGS. 1A-1C. The coating on the galvanized steel can be in the form of a ceramic coating as discussed above. A sheet of Basalt continuous fiber 240 is shown coupled to this coated steel sheet. An air gap 211 is also formed adjacent to this basalt continuous fiber material between the first coated steel sheet 210 and the second coated steel sheet 220 spaced a predefined distance from the first steel sheet. There is also a clip 230 which is coupled to the end of this steel sheet. This clip 230 has a first section 232, and a second section 234. First section 232 extends up at approximately a right angle from steel sheet 210. This first section then extends into curved second section 234. In this case, while the steel sheet is substantially rigid, this clip section can be elastic in nature such that it can undergo elastic deformation with another clip sliding inside as shown in FIG. 15C.

FIG. 15B is a side cross-sectional view of another panel 201 having a clip section 250. In this case, there is a coated steel sheet 212 which has an opposite spaced sheet 220 and a strip of basalt continuous fiber or BCF 240 disposed therein. Opposite spaced sheet 220 is spaced a predetermined distance from sheet 212 to form an air gap 241 between the first sheet 212, and the second sheet 220 with the BCF 240 disposed therein.

Clip 250 is disposed on one end and is made from the steel sheet. This allows the clip to be plastically or elastically deformed as it is inserted into the other opposed clip as shown in FIG. 15C. This creates a snap-in connection between the two sheets and locks the two sheets together. Clip 250 includes a first extending section and a second extending section formed as a leaf spring connected at a leaf spring hinge.

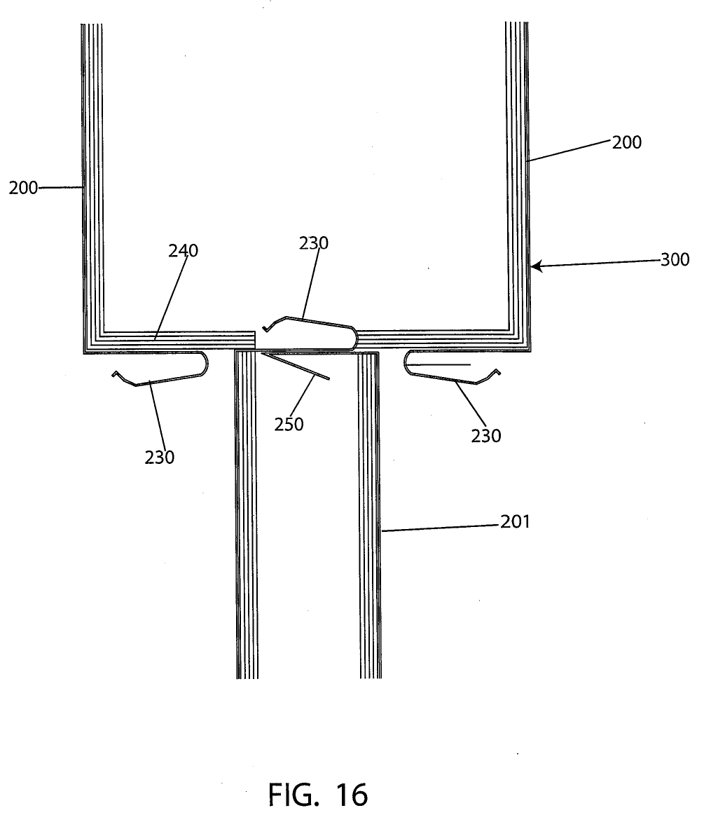

FIG. 16 discloses a side cross-sectional view of another configuration of the sheets 200 and 201 configured as a partition stop or a jamb 300 which is formed by the sheets joining together.

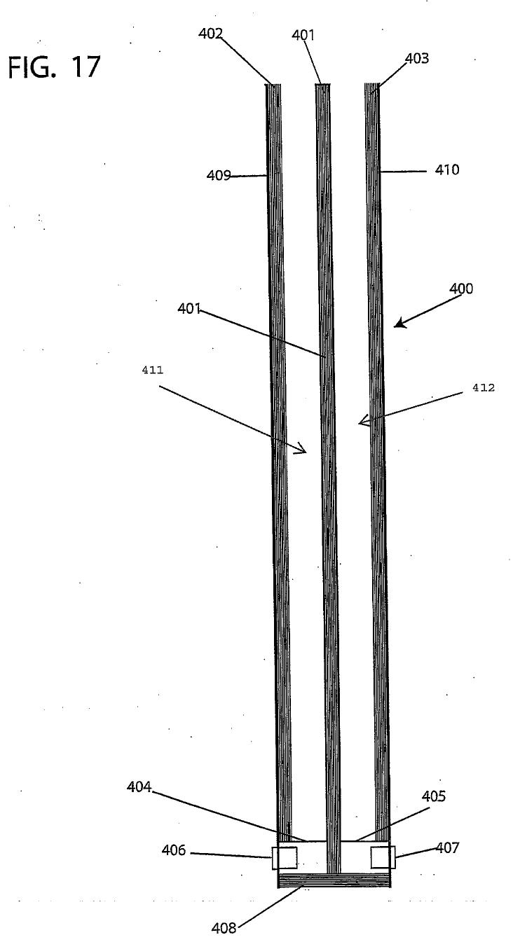

FIG. 17 is a side cross-sectional view of another embodiment, which discloses a series of panels including sheets 409 and 410 which are rigid steel sheets which can be coated with a ceramic insulator as disclosed above. In addition disposed between these sheets are three different layers of solid insulative material such as BCF or basalt continuous fiber 401, 402, and 403. The ends of these different compartments are sealed via sealing ends 404 and 405, such that air gaps 411 and 412 are formed in between these sealed panels. In addition, disposed at an end of this panel structure are snap in receptacle conduits 406 and 407. The end of this panel is also sealed via a sealing end 408 which is made from a steel sheet and BCF sheeting as well. This panel 400 forms a divider or partition wall for a house.

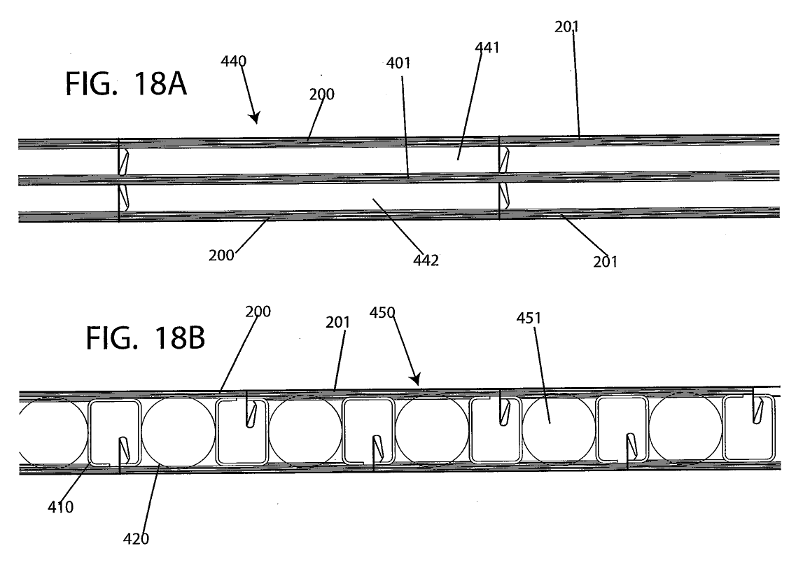

FIGS. 18A and 18B show two different structural panels used to form either a structural fire resistant wall or a fire resistant structural wall as well.

For example FIG. 18A shows a panel wall 440 which includes panel 200 of FIG. 15A, and panel 201 of FIG. 15B wherein these panels are coupled together as shown in FIG. 15C. In this case, the clips are snapped in to form a snap in connection with an additional partition wall 401 disposed in between. The clips 230 and 250 form a spacer between the two panels to provide the necessary air gaps 441 and 442 between the wall panels. As disclosed above, these air gaps are sealed in to provide a thorough insulation between an outer wall and an inner wall of a room.

FIG. 18B discloses a side cross sectional view of a structural wall formed from panels 200 and 201 snapped together on an end to end basis, and then coupled to structural members in between, wherein these structural members 410 and 420 are in the form of either C-shaped structural beams 410 or steel inertial heat tubes 420. As disclosed above, an air gap in the form of air 451 is disposed in the structural beams or in the inertial heat tubes. Because of the superior thermal insulation, there is also in many cases no need for an additional heating or cooling system as well.

Accordingly, while a few embodiments of the present invention have been shown and described, it is to be understood that many changes and modifications may be made thereunto without departing from the spirit and scope of the invention as defined in the appended claims.

What is claimed is:

1. A building panel comprising:
a) a plurality of sheets spaced apart from each other;
b) an insulative coating on at least one side of at least one of said plurality of sheets; and
c) an insulator disposed between at least two of said plurality of sheets.

2. The panel as in claim 1, wherein at least one of said insulator comprises air.

3. The panel as in claim 1, wherein said insulator comprises basalt continuous fiber.

4. The panel as in claim 1, wherein said insulator comprises air and basalt continuous fiber.

5. The panel as in claim 4, wherein said insulator comprises a first layer of air, a second layer of basalt continuous fiber and a third layer of air.

6. The panel as in claim 1, wherein at least one of said plurality of sheets comprises metal.

7. The panel as in claim 6, wherein at least one of said plurality of sheets, comprises steel.

8. The panel as in claim 6, wherein at least one of said plurality of sheets comprises galvanized steel.

9. The panel as in claim 6, wherein at least one of said plurality of sheets comprises steel coated with an aluminum zinc alloy.

10. The panel as in claim 1, wherein said plurality of sheets comprise at least two sheets spaced apart from each other.

11. The panel as in claim 10 wherein each of said at least two sheets is coated on a first side, and on an opposite side with said insulative coating.

12. The panel as in claim 11, wherein said insulative coating forms a substantially air sealed barrier between said first sheet and said second sheet.

13. The panel as in claim 9, further comprising a barrier formed at a peripheral region of each of said at least two sheets.

14. The panel as in claim 13, wherein said barrier comprises basalt continuous fiber.

15. The panel as in claim 10, wherein said insulator between said at least two sheets comprises the following profile: basalt continuous fiber, air, basalt continuous fiber, air, basalt continuous fiber.

16. The panel as in claim 10, wherein said insulator between said two sheets comprises the following profile: air, basalt continuous fiber, air, basalt continuous fiber, air.

17. The panel as in claim 1, wherein said panel has a cross sectional profile that comprises: steel sheet, air, steel sheet air, basalt continuous fiber, steel sheet, air, steel sheet.

18. The panel as in claim 1, wherein at least one of said steel sheets is coated with a ceramic insulator on at least one side.

19. The panel as in claim 1, wherein at least one of said plurality of sheets comprises a substantially C-shaped sheet.

20. The panel as in claim 19, wherein at least one of said plurality of sheets comprises a substantially C-shaped sheet having a base section, an extension section, and a lip.

21. A building sheet comprising:
a) a metallic sheet;
b) an alloy coating coupled to said metallic sheet; and
c) an insulative coating coupled to said alloy coating.

22. The building sheet as in claim 21, wherein said metallic sheet is made substantially from steel.

23. The building sheet as in claim 22, wherein said alloy coating comprises an aluminum zinc alloy.

24. The building sheet as in claim 21, wherein said insulative coating comprises a ceramic.

25. The building sheet as in claim 21, wherein said metallic sheet is corrugated.

26. The building sheet as in claim 21, wherein said metallic sheet comprises a galvalum corrugated sheet, such that said alloy comprises an aluminum zinc alloy coating said metallic sheet, and wherein said insulative coating comprises a coating comprising a ceramic material.

27. The building sheet as in claim 26, wherein said metallic sheet is corrugated.

28. The building sheet as in claim 21, wherein said sheet is C-shaped.

29. The building sheet as in claim 21, wherein said sheet comprises a substantially C-shaped sheet having a base section, an extension section, and a lip.

30. A building system comprising:
a) a plurality of structural members, configured to provide support;
b) at least one panel coupled to at least one of said at least one structural member, said at least one panel comprising at least two sheets spaced apart from each other; and
c) wherein said at least one panel is enclosed by said plurality of structural members, to form a sealed panel.

31. A method for creating a building panel comprising:
a) coating a first sheet of building material with an insulative material;
b) coating a second sheet of building material with an insulative material; and
c) coupling said first sheet and said second sheet to an intermediate structure, with said first sheet being spaced apart from the second sheet, to form a sealed panel.

32. The process as in claim 31, further comprising the step of providing an additional insulative material, before the step of coupling, and then coupling said insulative material to one of said intermediate structure or said sheet.

33. The process as in claim 31, wherein said insulative material coated on said first sheet and said second sheet comprises a ceramic insulator.

34. The process as in claim 31, wherein said additional insulative material comprises basalt continuous fiber (BCF).

35. The process as in claim 32, wherein said additional insulative material is coupled to said intermediate structure.

36. The process as in claim 32, wherein said first sheet of building material comprises a steel alloy comprising steel, zinc and aluminum, and said step of coating said first sheet comprises coating both sides of said first sheet with a ceramic coating, and wherein said step of coating said second sheet comprises coating both sides of said second sheet with a ceramic coating, and further comprising the step of coupling an additional insulator comprising basalt continuous fiber to said intermediate structure, wherein said intermediate structure comprises structural framing, and wherein said step of coupling said first sheet and said second sheet to said intermediate structure comprises coupling said coated first sheet to said intermediate structure, and coupling said coated second sheet to said intermediate structure, such that said coating on said first sheet and said second sheet forms a seal with said intermediate structure.
